(19) United States
(12) Patent Application Publication
(10) Pub. No.: US 2005/0122706 A1
(43) Pub. Date: Jun. 9, 2005

(54) Illuminated computer keyboard

(76) Inventor: Chih-Hung Sung, Shulin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/729,011

(22) Filed: Dec. 8, 2003

(51) Int. Cl. G01D 11/28

(52) U.S. Cl. 362/23

(57) ABSTRACT

An illuminated computer keyboard has a transparent layer, a resilient member, multiple printed circuit boards, an illuminant board and a casing to hold the foregoing elements. The transparent layer has multiple keys. The resilient member is mounted under the transparent layer, is translucent and has multiple resilient protrusions corresponding respectively to the keys in the transparent layer to press the keys against the transparent layer. The multiple printed circuit boards are mounted under the resilient member, are translucent and connect the keys electrically to the computer. The illuminant board is mounted under the multiple printed circuit boards and is powered by a power supply. When the illuminant member is illuminating and light passes through the transparent layer, the keyboard can be clearly seen and used in the dark.

### BACKGROUND OF THE INVENTION

1. Field of the Invention

The present invention relates to a computer keyboard, and more particularly to an illuminated computer keyboard that can be used in the dark.

2. Description of Related Art

When a person is using a computer and electric power is unexpectedly interrupted, data not saved to computer memory will be lost. To prevent unexpected loss of memory, the computer is connected to an uninterruptible power supply (UPS) to provide electric power when the electric power is lost unexpectedly. However, loss of electric power also causes the lights to go out. Although the computer is connected to a UPS and has power, the computer keyboard is lighted by ambient light and light from the monitor so the keyboard may not be able to be seen clearly. If a person does not know the location of the keys on the keyboard, the computer keyboard cannot be used in the dark even though the computer is operable.

The present invention has arisen to mitigate or obviate the disadvantages of conventional computer keyboards.

### SUMMARY OF THE INVENTION

The main objective of the present invention is to provide an illuminated computer keyboard that can be used in the dark.

To achieve the objective, an illuminated computer keyboard in accordance with the present invention comprises a transparent layer, a resilient member, multiple printed circuit boards, an illuminant board and a casing. The transparent layer has multiple keys. The resilient member is mounted under the transparent layer, is translucent and has multiple resilient protrusions corresponding respectively to the keys in the transparent layer to press the keys against the transparent layer. The multiple printed circuit boards are mounted under the resilient member, are translucent and have multiple switches corresponding respectively to the keys on the transparent layer. The illuminant board is mounted under the multiple printed circuit boards and is run by a power supply. The casing hold the transparent layer, the resilient member, the multiple printed circuit boards and the illuminant board. When the illuminant board is illuminated and light passes through the transparent layer, the keyboard can be clearly seen and used in the dark.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an illuminated computer keyboard in accordance with the present invention;

FIG. 2 is an exploded perspective view of the illuminated computer keyboard in FIG. 1;

FIG. 3 is an enlarged top plan view in partial section of an embodiment of an illuminant board and multiple printed circuit boards of the illuminated keyboard in FIG. 1;

FIG. 4 is a circuit diagram of a drive circuit for the illuminant board and a transformer of the illuminated keyboard in FIG. 1;

FIG. 5 is a perspective view of a first embodiment of the illuminated computer keyboard in a notebook computer;

FIG. 6 is a perspective view of a second embodiment of the illuminated computer keyboard used with a desktop computer.

### DETAILED DESCRIPTION OF THE INVENTION

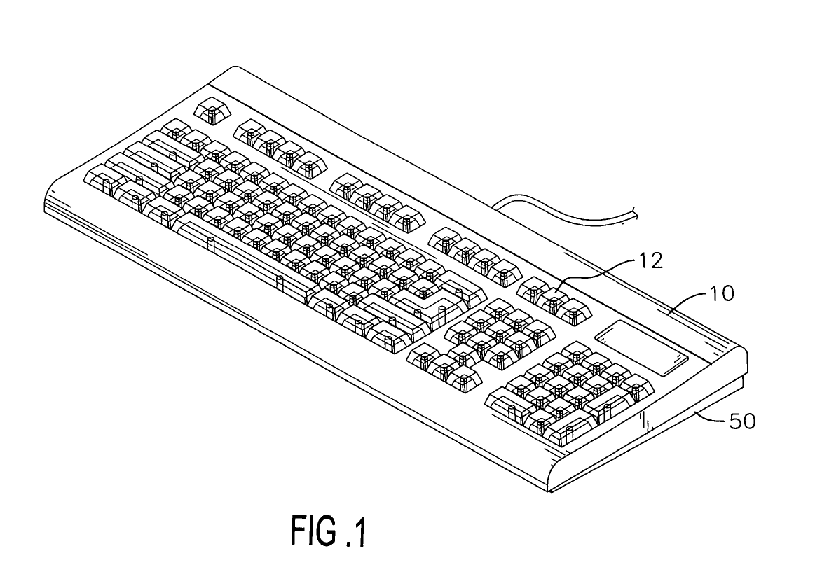

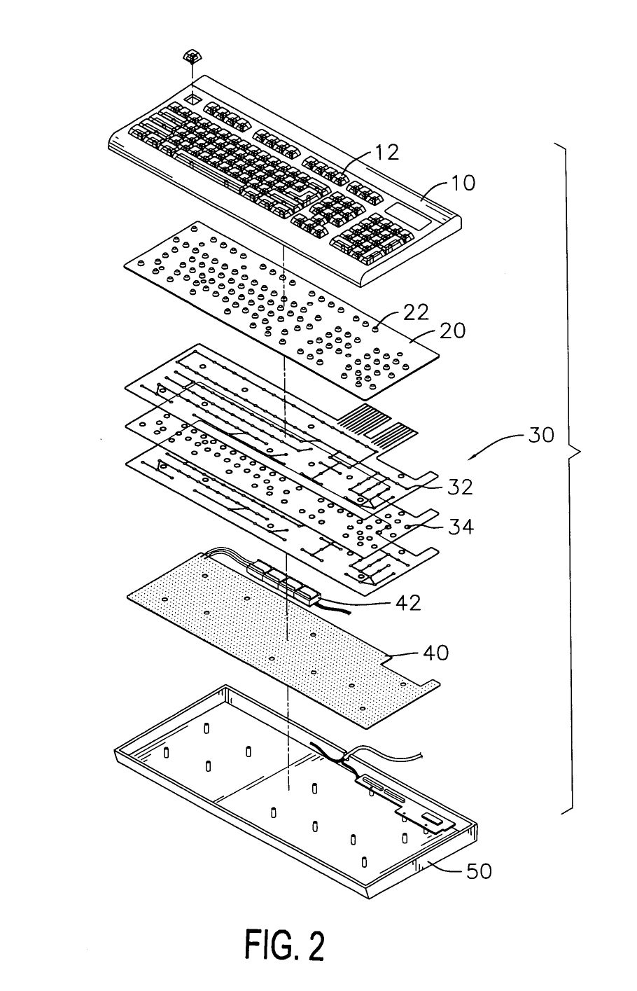

With reference to FIGS. 1 and 2, an illuminated computer keyboard in accordance with the present invention comprises a transparent layer (10), a resilient member (20), multiple printed circuit boards (30), an illuminant board (40) and a casing (50). The transparent layer (10) is transparent and has a bottom surface (not numbered) and multiple keys (12). The keys (12) are movably seated through the bottom surface of the transparent layer (10). The resilient member (20) is translucent, is mounted under the transparent layer (10) and has multiple resilient protrusions (22), which correspond respectively to the keys (12) and press the keys (12) against the bottom surface of the transparent layer (10).

The multiple printed circuit boards (30) are translucent, are mounted under the resilient member (20), form multiple electrical switches (not numbered) and may comprise a top printed circuit board (not numbered), an insulation board (not numbered) and a bottom printed circuit board (not numbered). The electrical switches correspond respectively to the keys (12) on the transparent layer (10). The top and bottom printed circuit boards have multiple electrical contacts (32) corresponding respectively to the keys (12) of the transparent layer (10), which send an electrical signal unique to the corresponding key (12) to the computer when the electrical contacts (32) make contact. The insulation board has multiple holes (34) corresponding respectively to the electrical contacts (32) on the top and bottom printed circuit boards. The holes (34) in the insulation board allow the electrical contacts (32) on the top printed circuit board to make contact with the electrical contacts (32) on the bottom printed circuit board. The structure and function of the multiple printed circuit boards (30) are known to people skilled in the art and are not further described.

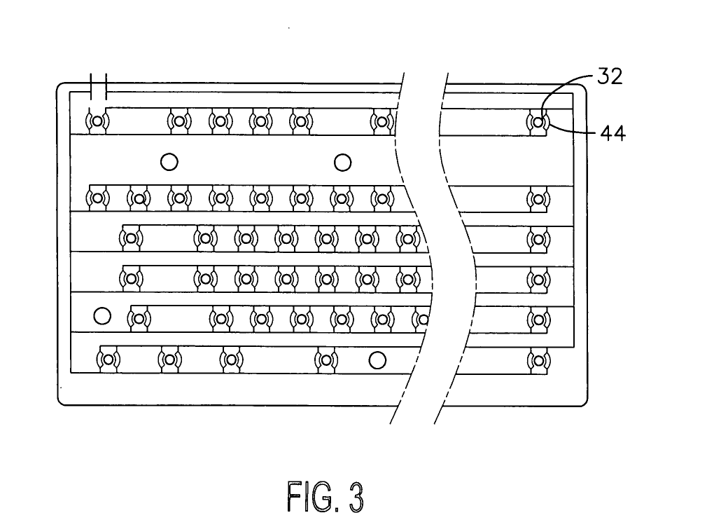

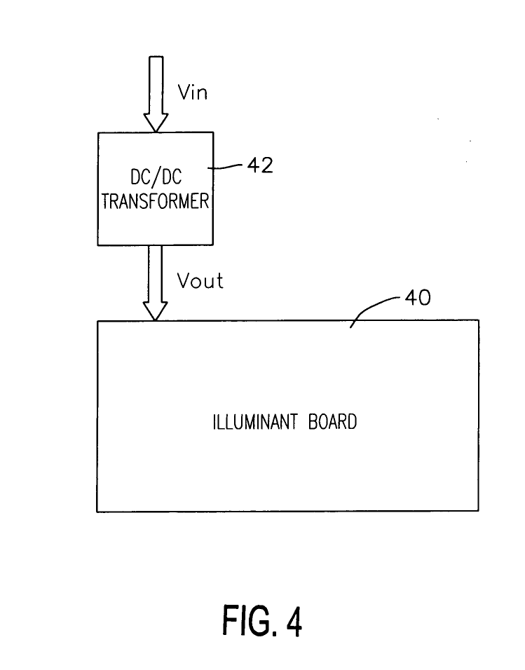

With further reference to FIG. 3, the illuminant board (40) is mounted under the multiple printed circuit boards (30) and powered by a power supply. Preferably, the illuminant board (40) is powered by the computer power supply. The illuminant board (40) may be a single illuminating element or may have multiple arc-shaped illuminators (44) with inside faces (not numbered) and outside faces (not numbered). The illuminant board (40) preferably is an electroluminescent panel. The multiple arc-shaped illuminators (44) are formed in pairs and around the corresponding electrical switch on the printed circuit boards (30). The inside faces of the arc-shaped illuminators in each pair are faced each other. With further reference to FIG. 4, the illuminant board (40) further comprises a transformer (42) connected to a computer power supply (not shown). The transformer (42) receives an input voltage from the computer power supply and outputs an output voltage to the illuminant board (40).

The casing (50) holds the transparent layer (10), the resilient member (20), the multiple printed circuit boards (30) and the illuminant board (40).

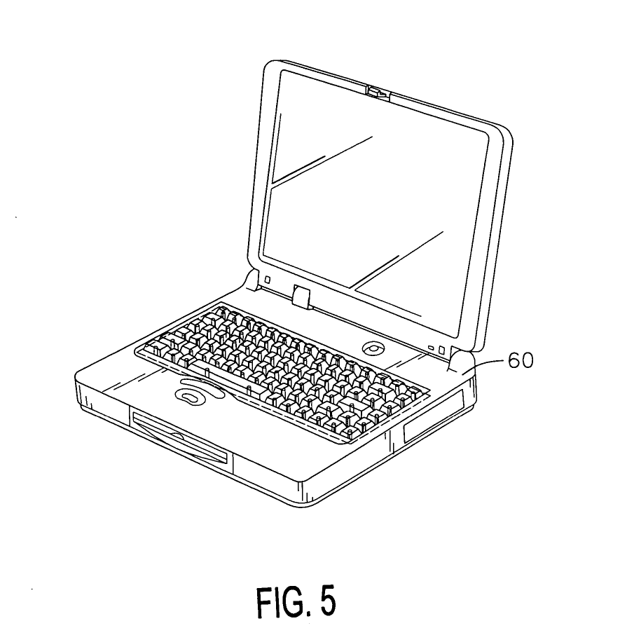

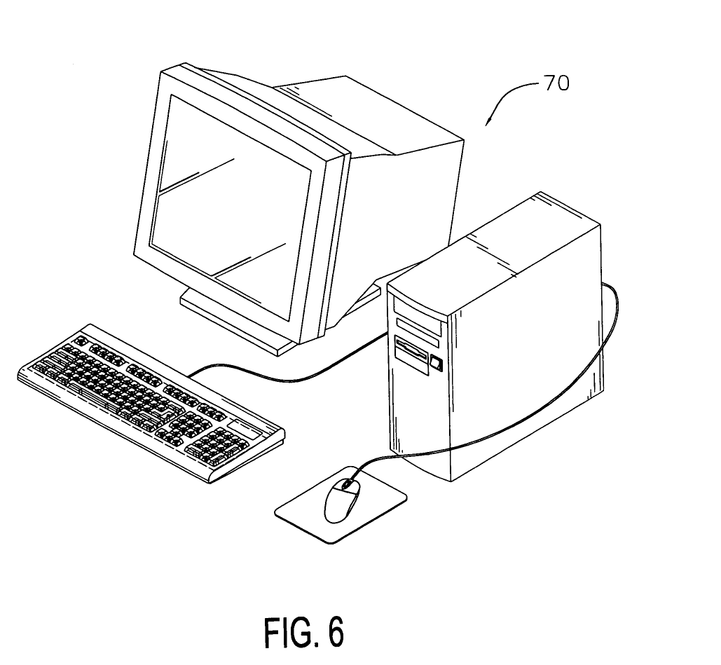

With further reference to FIGS. 5 and 6, the illuminated computer keyboard can be used in a notebook computer (60) or a desktop computer (70). When the illuminant board (40) is illuminating and light passes through the transparent layer (10), the transparent layer (10) can be clearly seen and used in the dark. Furthermore, the preferred luminescent board has the advantages of saving electricity and producing no heat.

Although the invention has been explained relative to its preferred embodiment, many other possible modifications and variations can be made without departing from the spirit and scope of the invention as hereinafter claimed.

1. An illuminated computer keyboard comprising a transparent layer having a bottom surface and multiple keys movably mounted through the bottom surface;
a resilient member mounted under the transparent layer, being translucent and having multiple resilient protrusions corresponding respectively to the keys in the transparent layer;
multiple printed circuit boards mounted under the resilient member, being translucent and respectively having multiple electrical switches corresponding respectively to the keys in the transparent layer;
an illuminant board mounted under the multiple printed circuit boards and adapted to be connected to a power supply; and
a casing holding the transparent layer, the resilient member, the multiple printed circuit boards and the illuminant board.

2. The illuminated computer keyboard as claimed in claim 1, wherein the illuminant board is an electroluminescent panel.

3. The illuminated computer keyboard as claimed in claim 2, wherein the illuminant board is a single illuminating element.

4. The illuminated computer keyboard as claimed in claim 2, wherein the illuminant board has multiple arc-shaped illuminators on the illuminant board, wherein
the multiple arc-shaped illuminators have inside and outside faces, and are formed in pairs respectively around one of the electrical switches on the printed circuit board, and the inside faces of the arc-shaped illuminators in each pair face each other.

5. The illuminated computer keyboard as claimed in claim 2 further comprising a transformer electrically connected to the illuminant board and adapted to be connected to a power supply of the computer.

6. The illuminated computer keyboard as claimed in claim 1, wherein the illuminated computer keyboard has three printed circuit boards that are namely a top printed circuit board, an insulation board and a bottom printed circuit board, wherein
the top and bottom printed circuit boards have multiple electrical contacts corresponding respectively to the keys in the transparent layer, which send an electrical signal unique to the corresponding key to the computer when the electrical contacts make contact;
the insulation board has multiple holes corresponding respectively to the electrical contacts on the top and bottom printed circuit boards.
